(19) United States
(12) Patent Application Publication
(10) Pub. No.: US 2004/0131504 A1
(43) Pub. Date: Jul. 8, 2004

(54) Remote temperature sensing of small volume and related apparatus thereof

(76) Inventors: James P. Landers, Charlottesville, VA (US); Braden Giordano, Fairfax, VA (US); Jerome P. Ferrance, Charlottesville, VA (US); Thomas Wavering, Charlottesville, VA (US)

Correspondence Address: BLANK ROME LLP, 600 NEW HAMPSHIRE AVENUE, N.W., WASHINGTON, DC, 20037, US

(21) Appl. No.: 10/664,064

(22) Filed: Sep. 17, 2003

Related U.S. Application Data
(60) Provisional application No. 60/411,432, filed on Sep. 17, 2002.

(51) Int. Cl. B01L 3/00

(52) U.S. Cl. 422/99

(57) ABSTRACT

The present invention relates to methods of and apparatus for rapidly and accurately measuring the temperature of a small volume sample. The remote temperature sensor contains an optical interferometric sensor, preferably an extrinsic Fabry-Perot interferometer (EFPI), for measuring the difference in the distance traveled by a reference reflection and a sensing reflection. Because the refraction index of a solution is proportional to temperature, the output of the optical interferometric sensor can be converted to a temperature with a standard curve. Further, the present invention also provides methods and apparatus for measuring the temperature of the sample in performing non-contact (remote) thermocycling on small, micro to nanoliter, volume samples, wherein each cycle can be completed in as little as a few seconds.

### FIELD OF THE INVENTION

The present invention relates to methods and apparatus for rapidly and accurately measuring the temperature of a small volume sample. More specifically, the present invention relates to methods and apparatus for measuring the temperature of the sample in performing non-contact thermocycling on small, micro to nanoliter, volume samples, wherein each cycle can be completed in as little as a few seconds.

### BACKGROUND OF THE INVENTION

Numerous analytical methods require that a sample be heated to a particular temperature and then cooled to a particular temperature. Often, sequential heating and cooling steps, known as thermocycling, are required. Various methods involve cycling through two or more stages all with different temperatures, and/or involve maintaining the sample at a particular temperature stage for a given period of time before moving to the next stage. Accordingly, thermocycling of samples can become a time consuming process. In addition, these methods often require the precise control of temperature at each stage of the cycle; exceeding a desired temperature can lead to inaccurate results.

Two factors that are typically important, therefore, in the performance of effective thermocycling on a sample are the speed and homogeneity of the apparatus and the methods used. Cycle times are largely defined by how quickly the temperature of the sample can be changed, and relate to the heat source itself and the rate of heat transfer to the sample. Uniformity of sample temperature is important to ensure that reproducible and reliable results are obtained. Typically, increasing cycle speeds makes it harder to maintain homogenous sample temperatures.

The concept of using elevated temperatures to effect chemical, biological and biochemical reactions is commonly known and expressed as the law of Arrhenius. Generally, an increase in temperature of a reaction translates into an increase in the rate of the reaction. Reaction parameters, such as the activation of the reaction, the increase in dissolution of the reaction components, the desolvation of the substrate and the specificity of the catalysis are temperature dependent. Exact or nearly exact maintenance of a reaction temperature is often critical in most biochemical/biological processes to guarantee their successful completion. Therefore, great efforts are made in the daily routine of a chemical/biochemical laboratory to control the temperature conditions during a reaction. It is expected that better temperature control increases the performance of most reactions, for example, increasing the specificity of proteolytic reactions.

There is particular interest in rapid and homogenous thermocycling when performing DNA amplification via polymerase chain reaction (PCR). PCR is a process by which a single molecule of DNA (or RNA) from an organism can be amplified by a factor of 10⁶ to 10⁹. This procedure requires the repetition of heating and cooling cycles in the presence of an original DNA target molecule, specific DNA primers, deoxynucleotide triphosphates, and DNA polymerase enzymes and cofactors. Heating accounts for a denaturing of the sample while cooling results in annealing of the sample. At a temperature typically between the denaturing and annealing temperatures, extension of the annealed primers using an enzyme occurs to replicate the DNA strand or portion of the strand. Extension of the primer can also occur at the same temperature as annealing, depending on the specifics of the reaction. Each heating/cooling cycle produces a doubling of the target DNA sequence, leading to an exponential accumulation of the target sequence. PCR based technology has been applied to a variety of analyses, including environmental and industrial contaminant identification, medical and forensic diagnostics, and biological research.

There are a number of biochemical reactions that require accurate and rapid thermocycling. Additionally, there are reactions whose specificity can be enhanced when conducted in a rapid and accurate thermocycling environment. The PCR reaction places very high demands on the accuracy of the thermocycling parameters and is, therefore, an ideal assay to test the accuracy of the thermocycling method and apparatus.

U.S. Pat. No. 4,683,202 generally describes the PCR concept, in which a stretch of DNA is copied using a polymerase. Generally, the procedure involves annealing a piece of primer DNA at a first temperature to any stretch of single-stranded DNA template with a complementary sequence. The DNA polymerase copies the primed piece of DNA at a second given temperature. At a third given temperature, the newly copied DNA and the primer dissociate from the template DNA, thereby regenerating single-stranded DNA. The temperature of the sample is returned to the first temperature to allow the primer to attach itself to any strand of single-stranded DNA with a complementary sequence, including the DNA strands that were synthesized in the immediately preceding cycle. In that manner, the template DNA is amplified or reproduced any number of times, depending on how many times the template DNA occurs in the sample, and the number of cycles completed. The procedure can also be performed using RNA.

Most existing methods and techniques of thermocycling in benchtop instrumentation are indirect with respect to the effect of the heating source on the sample. Most thermocycling approaches heat and/or cool a circulating medium, such as water or air, that affects the container which holds the sample and, subsequently, subjects the sample itself to the desired thermocycling process. The rate of the cycling process depends on the effectiveness of the heat transfer between the circulating medium and the sample.

For example, U.S. Pat. No. 5,504,007 discloses a thermocycle apparatus having a body containing a thermally conductive liquid. The liquid is contained within the body of the apparatus, and the temperature of the liquid alternated between lower and higher temperatures in repeating cycles. A well or container for holding a sample of material is held in contact with the liquid and conducts the cyclic temperature changes of the liquid to the sample.

U.S. Pat. No. 5,576,218 discloses a method for the thermocycling of nucleic acid assays using a blended fluid stream produced from constant velocity, constant volume, and constant temperature fluid streams. Using these streams, a variable temperature, constant velocity, constant volume fluid stream is introduced into a sample chamber for heating and cooling the samples contained therein. The temperature of the blended fluid stream is varied by diverting and altering the ratio of the constant temperature fluid streams relative to one another.

U.S. Pat. No. 5,508,197 discloses a thermocycling system based on the circulation of temperature controlled water directly to the underside of a thin-walled polycarbonate microtiter plate. The water flow is selected from a manifold fed by pumps from heated reservoirs.

Other methods are reported for heating a sample through the use of heated air. U.S. Pat. No. 5,187,084 discloses an apparatus and method for performing thermocycling on a sample using an array of sample containing vessels supported in a reaction chamber, through which air at controlled temperatures is forcibly circulated as a heat-transfer medium in heat exchange relationship with the vessels. The temperature of the air is controlled as a function of time to provide a preselectable sequence defining a temperature profile. The profile is a repetitive cycle that is reproduced to effect replication of and amplification of the desired sequence of the DNA.

U.S. Pat. No. 5,460,780 discloses a device for rapidly heating and cooling a reaction vessel through various temperatures in PCR amplification utilizing a device for heating at least one side wall of a reaction vessel, device for cooling the heating device at repeated intervals and device for moving the reaction vessel and/or heating and cooling relative to each other. In one embodiment, heated air is used to heat the reaction vessel.

Similarly, U.S. Pat. No. 5,455,175 demonstrates that rapid, non-contact PCR can be accomplished in glass capillaries using air heated by foam lining the chamber in which the capillaries are placed; the foam is heated first by a halogen lamp.

Another common approach for thermocycling is through intimate contact between a reaction vessel holding the reaction medium and a heating block that is rapidly heated and cooled (for example, by using a Peltier element that can both heat and cool). That is the basis of most commercially available PCR instrumentation.

For example, U.S. Pat. No. 5,525,300 discloses an apparatus for generating a temperature gradient across a heat conducting block.

U.S. Pat. No. 5,498,392 discloses chip-like devices for amplifying a preselected polynucleotide in a sample by conducting a polynucleotide polymerization reaction. The devices comprise a substrate microfabricated to define a sample inlet port and a mesoscale flow system, which extends from the inlet port. A polynucleotide polymerization reaction chamber containing reagents for polymerization and amplification of a polynucleotide is in fluid communication with the inlet port. A heat source and, optionally, a cooling source are used to heat and/or cool the chip.

Wilding and co-workers, Nucleic Acids Res., 24:380-385 (1996), demonstrated that PCR could be carried out in a microfabricated silicon glass chip-like chamber. By contacting enclosed 12 microliter reaction chambers microfabricated in glass to a block heater which cycled between two temperatures, they were able to obtain effective and reproducible PCR amplification, as confirmed by removing the PCR product and evaluating it using capillary electrophoresis. Similarly, Northrup and co-workers, Anal. Chem., 68:4081-4086 (1996), accomplished PCR amplification of DNA in a microfabricated silicon PCR device that could be directly interfaced with an electrophoretic chip for PCR product analysis. The device contained disposable polypropylene liners to retain the PCR mixture which could be cycled between two temperatures using polysilicon heaters in direct contact with the PCR chamber and cooled either passively or by air drawn along the heater surfaces of the reaction chamber. The device was interfaced with the electrophoretic chip by forcing it into the 1 mm drilled holes in the electrophoretic chip.

All of the above references, however, describe PCR amplification methods wherein the vessel containing the sample is contacted directly by a heater or another heat source, which transfers heat to the vessel in which the sample is contained. The vessel, in turn, heats the sample. Since these techniques rely on the intimate contact between the circulating medium and the reaction vessel, the surface-to-volume ratio of the reaction vessel is of utmost importance to the effectiveness of the heating step; the higher that ratio the better the PCR reaction.

PCT publication WO 96/41864 discloses a diode laser heated microreaction chamber with a sample detection device. A heat source, such as an IR or UV source, is used to heat the reagents to a thermally induced chemical reaction. Such heating device can be used, for example, in conjunction with the microfabricated reactor described in U.S. Pat. No. 5,639,423.

U.S. Pat. Nos. 6,413,766 and 6,210,882, which are incorporated herein by reference, disclose thermocycling using both a non-contact heating source and a non-contact cooling source. The heating source is provided by optical energy from an IR source. The cooling source is provided by forcing air across the reaction vessel. The temperature sensor in the system, however, is a thermocouple that requires direct contact with the sample fluid.

None of the above references teach methods and apparatus for performing ultrafast and reliable thermocycling using all non-contact heating source, cooling source, and temperature sensor for providing sharp and rapid transitions from one temperature to another.

The possibilities of thermocycling on a device in which temperature control is achieved using a temperature sensor that is predetermined by the initial design of the chip are limited, as the location of the temperature sensor is typically part of the chip itself. Thus, those microdevices used in thermocycling are spatially constrained; and the devices are not flexible with respect to temperature sensing on different locations within or at the microdevice structure.

In addition, the design of single-use modules for various diagnostic and monitoring purposes with integrated temperature sensor is very complex, and becomes cumbersome and difficult to use especially when numerous samples are to be tested. Therefore, the inexpensive production of such devices, normally a major advantage of microfabrication technology, is compromised.

There is a need, therefore, for improved methods and apparatus for remote temperature sensing of analytical samples in a fast and reliable manner. There is a further need for such methods and apparatus for use with miniaturized thermocylcing, such as that for the polymerase chain reaction (PCR) amplification. Remote temperature sensing is used herein to describe temperature measuring without directly contacting the solution of interest. Remote temperature sensing offers two very important benefits for small volume microdevice thermocycling applications. First, there is no added thermal mass from the detection system. That is important in the rapid heating and cooling needed for decreasing the reaction times. Second, no additional components need be fabricated into the microchip itself in order to accurately measure the temperature of a solution within a microfabricated chamber. That decreases the cost, and may allow a single system to monitor temperatures in a number of positions on a single device with no additional connections.

### SUMMARY OF THE INVENTION

Remote sensing of the temperature of a solution within a small volume chamber can be accomplished by measuring changes in the refractive index of the solution. Optical interferometric sensing, preferably Extrinsic Fabry-Perot Interferometry (EFPI), technology is capable of measuring very small distances based on the formation of a low-finesse Fabry-Perot cavity between two reflective surfaces. That is accomplished by passing light through an optical fiber, and measuring differences in the light reflected from the two reflective surfaces back through the same fiber. Often, one of those interfaces is the fiber/air interface at the polished end of the fiber, but in microchip measurements, the top surface of the device, and the bottom of the microfabricated chamber can be used to define at least one cavity. Constructive and destructive interference occurs between the reflected light waves based on the path length difference traversed. Within the microchip, the distance of the light path through the solution, to reflect from the bottom of the microfabricated chamber, changes as the refractive index of the solution changes. Since the refractive index is a function of the temperature of the solution, that change in the distance traveled by the light reflected from the chamber bottom can be used to determine the temperature of a solution within the microchip chamber. With a fiber placed above the section of the microchip to be interrogated, and with the appropriate calibration, the solution temperature can be determined rapidly (in microseconds) and with an accuracy that is on the order of about ±0.5° C. In some application, multiple reflections may be possible. In those cases, the individual path lengths can be isolated using optical path length multiplexing methods.

Therefore, it is an object of the present invention to provide a method and apparatus for temperature sensing of a small volume of fluid using EFPI.

It is further object of the present invention to provide a method and apparatus for PCR on a microchip having all remote heating, cooling and temperature sensing.

### BRIEF DESCRIPTION OF THE DRAWINGS

FIG. 1 depicts the principle of operation of an optical interferometric sensor;

FIG. 2 depicts a block diagram of the remote temperature sensor of the present invention;

FIG. 3 shows the return signal of an optical interferometric sensor of the present invention for a 60 μm gap;

FIG. 4 shows the return signal of an optical interferometric sensor of the present invention for a 120 μm gap;

FIG. 5 shows an eight channel optical switch capable of being used with the present invention;

FIG. 6 shows a preferred thermocycling system of the present invention;

FIG. 7 shows the top view of a microchip used in an embodiment of the present invention;

FIG. 8 shows the optical interferometric sensor set-up with the microchip according to an embodiment of the present invention; and

FIG. 9 compares the temperature profiles using a thermocouple and using an EFPI remote temperature sensor.

### DETAILED DESCRIPTION OF THE INVENTION

The present invention is generally directed to an apparatus and method for performing remote, rapid, accurate temperature measurement on small volume samples. Remote temperature measurement, in the context of this application, is used to describe temperature measuring without directly contacting the solution of interest. The term “small volume” as used herein refers to volumes in the picoliters (pL) to microliters (μL) range, preferably about 100 pL to about 100 μL, most preferably about 1 nL to about 10 μL.

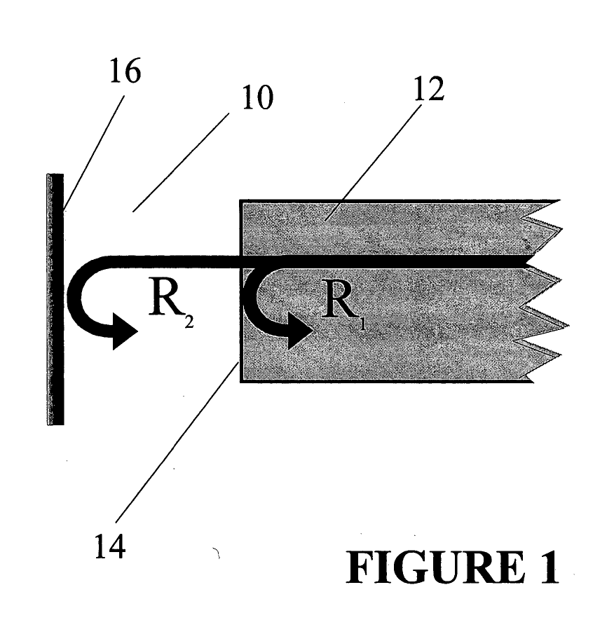

The present invention uses an optical interferometric sensor, preferably an Extrinsic Fabry-Perot Interferometer (EFPI), to remotely measure temperature of a small volume sample. Optical interferometric sensor technology is generally a distance measurement technique based on the formation of a low-finesse Fabry-Perot cavity between the polished end face of a fiber and a reflective surface which defines a gap. The operational principle of an Optical interferometric sensor is shown schematically in FIG. 1. Light is passed through the fiber 12, where a portion of the light R₁ is reflected off the fiber/air interface 14. The remaining light propagates through the gap 10 between the fiber 12 and the reflective surface 16 and is reflected back into the fiber R₂. R₁ is the reference reflection while R₂ is the sensing reflection. Those two lightwaves interfere constructively or destructively based on the path length difference traversed by the sensing reflection relative to the reference reflection, and travel back through the single mode fiber to the demodulation unit. With multiple reflective surfaces placed in the path of the light, the distances between any two surfaces can be measured by isolating the interference from reflections at only those two surfaces. The present invention takes advantage of the fact that the refractive index is a function of the temperature. Thus, the path length traveled by the sensing reflection R₂ depends on the temperature of the fluid contained within the gap 10. Therefore, by properly calibrating and correlating the output of an optical interferometric sensor with the temperature of a fluid within a gap, the optical interferometric sensor can be used to remotely measure the temperature of a small volume. For optimal performance in temperature sensing, the gap is preferably about 5 μm to about 200 μm.

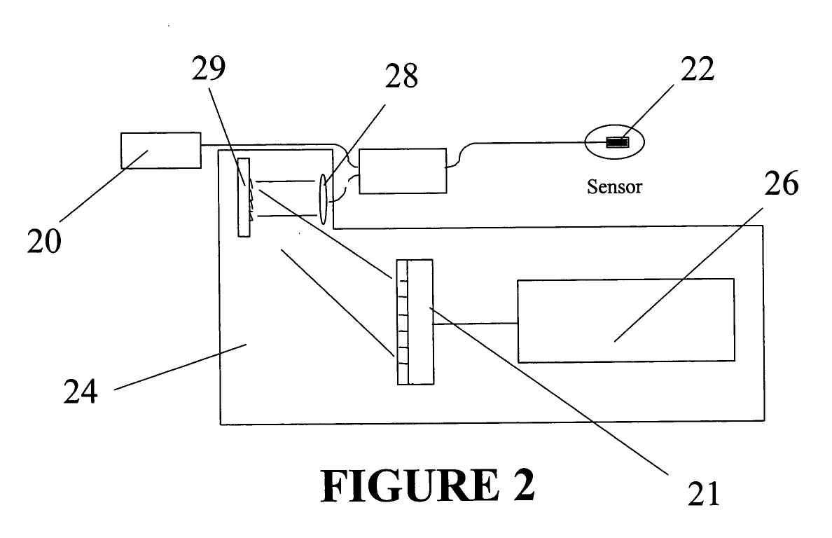

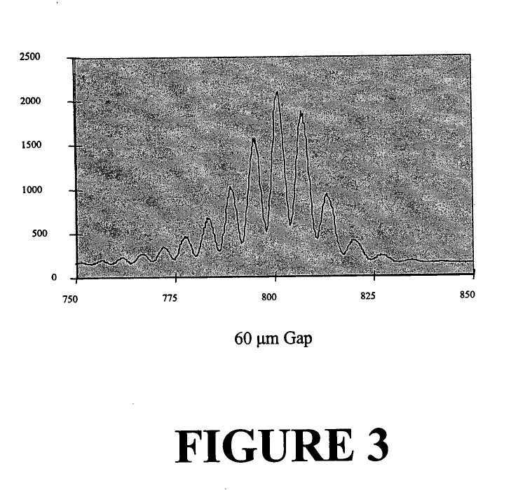

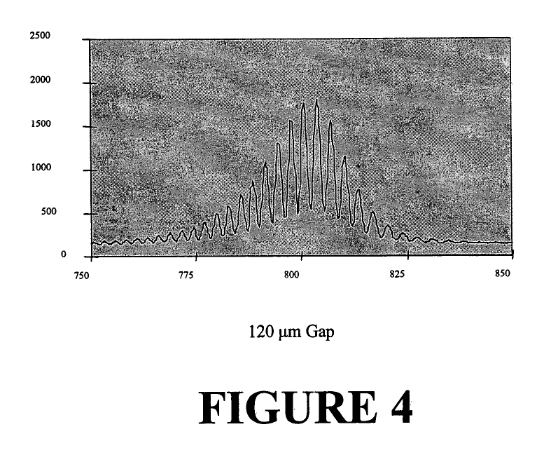

FIG. 2 depicts a block diagram of the remote temperature sensor system of the present invention. A broadband light source 20 is used to address the sensor head 22, while the returned signal is analyzed with a support system 24 for displaying the output of the optical interferometric sensor, and a signal processor 26. The support system 24 is preferably a spectrophotometer which comprises a least a lens 28, a grating 29, and a CCD array 21. The plots in FIGS. 3 and 4 show the returned raw signal from the optical interferometric sensor at two different sensor air gaps (60 μm and 120 μm gaps, respectively). Absolute gap information is contained in the frequency content of the signal.

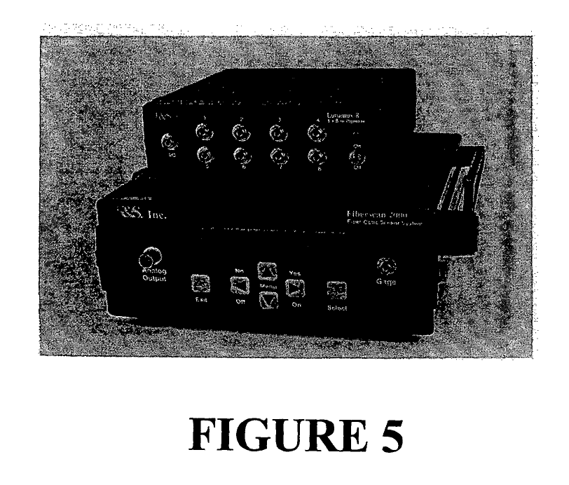

In an embodiment of the present invention, several optical interferometric temperature sensors can be used to simultaneously detect temperatures at a plurality of gaps. By using appropriate filtering, several different temperature sensor signals can be simultaneously analyzed. Multiple measurements from multiple temperature sensors can be performed by utilizing optical switches to scan between multiple sensors. FIG. 5 shows a photograph of an eight channel system appropriate for the present invention from R&S, Inc. This system has been demonstrated in numerous medical, biotechnology, aerospace, and industrial applications for multiplexed absolute low speed (<100 Hz) measurement of strain, pressure, temperature, biological targets, chemical targets, etc. The advantages of this system are its multiplexing capability, robustness, operating range, and the fact that its measurement is absolute.

The remote temperature sensor of the present invention is most appropriate for use with miniaturized analytical processes, particularly those on chips or microflluidic devices. Preferably, those PCR processes, along with the use of the present remote temperature sensor, also use remote heating and cooling. In doing so, the chip is manufactured without having to fabricate integral heating, cooling and temperature measuring elements for each individual chip. That results in significant simplification of the chip and a reduced cost of manufacturing. Further, the remote heating, cooling, and temperature sensing apparatus can be repeatedly reused with other chips and does not have to be discarded with the chip after use. Because those elements are remote, physical connection between the chip and the heating means, cooling means, and temperature sensing means do not have to be engineered into the chip itself.

Applications of the thermocycling method of the present invention are numerous and generally encompass any analytical system in which the temperature of a sample is regulated and/or changed. The present invention is particularly applicable to analytical systems wherein fast or ultrafast transition from one temperature to the next is needed, and in which it is important that exact or nearly exact temperatures be achieved.

For example, the present apparatus and methods are suitable for testing and incubation and treatment of biological samples typically analyzed in a molecular biology laboratory or a clinical diagnostic setting. The accuracy of the thermocycling method of the present invention makes it particularly suitable for use in nucleic acid replication by the polymerase chain reaction (PCR). Any reaction that benefits from precise temperature control, rapid heating and cooling, continuous thermal ramping or other temperature parameters or variations can be accomplished using this method discussed herein. Other applications include, but are not limited to, the activation and acceleration of enzymatic reactions, the deactivation of enzymes, the treatment/incubation of protein-protein complexes, DNA-protein complexes, DNA-DNA complexes and complexes of any of these biomolecules with drugs and/or other organic or inorganic compounds to induce folding/unfolding and the association/dissociation of such complexes. The following applications illustrate the usefulness of the present thermocycling apparatus and methods, representing only some of the possible applications.

A common procedure in the protocols of molecular biology is the deactivation of proteins through heat. One of the most basic procedures in molecular biology is the cleavage of proteins and peptides into discrete fragments by proteases/digestion enzymes, such as trypsin. A thermocycling procedure is typically used to activate the enzyme at an elevated temperature followed by: the incubation of the enzyme during the reaction to sustain the enzymatic catalysis; the heat inactivation of the enzyme; and the final treatment/analysis at ambient temperature. Typically, the reaction components are incubated at 40° C. for 60 minutes until the reaction is completed, after which the enzyme activity has to be stopped to avoid unspecific cleavage under uncontrolled conditions. Many enzymes, such as trypsin, can be irreversibly inactivated by incubation for 10 minutes at higher temperature, such as 95° C. The sample is then cooled back to ambient temperature and ready for downstream analysis. Such deactivation of enzymes is taught, for example, in Sequencing of proteins and peptides: Laboratory Techniques in Biochemistry and Molecular Biology, ed. G. Allen, pages 73-105.

The same principle of heat inactivation can be used to inactivate restriction endonucleases that recognize short DNA sequences and cleave double stranded DNA at specific sites within or adjacent to the recognition sequence. Using the appropriate assay conditions (for example, 40° C. for 60 min), the digestion reaction can be completed in the recommended time. The reaction is stopped by incubation of the sample at 65° C. for 10 minutes. Some enzymes may be partially or completely resistant to heat inactivation at 65° C., but they may be inactivated by incubation for 15 minutes at 75° C. Such methods are taught, for example, by Ausubel et al. Short Protocols in Molecular Biology, 3rd Ed., John Wiley & Sons, Inc. (1995) and Molecular Cloning: A Laboratory Manual, J. Sambrook, Eds. E. F. Fritsch, T. Maniatis, 2nd Ed.

Similar to the heat inactivation of proteins for the control of enzymatic activity, the sample processing of proteins for electrophoretic analysis often requires the denaturation of the protein/peptide analyte before the separation by electrophoretic means, such as gel electrophoresis and capillary electrophoresis, takes place. For example, a 5 minute heat denaturation (which provides for the destruction of the tertiary and secondary structure of the protein/peptide) at 95° C. in an aqueous buffer in the presence or absence of denaturing reagents, such as SDS detergent, allows the size dependent separation of proteins and peptides by electrophoretic means. That is taught, for example, in Gel Electrophoresis of Proteins: A Practical Approach, Eds. B. D. Hames and D. Rickwood, page 47, Oxford University Press (1990).

Thermocycling of samples is also used in a number of nonenzymatic processes, such as protein/peptide sequencing by hydrolysis in the presence of acids or bases (for example, 6M HCl at 110° C. for 24 hours) into amino acids. Studies involving the investigation of the interaction of biomolecules with drugs and/or drug candidates are frequently conducted under conditions requiring precise temperature control to obtain binding characteristics, such as kinetic association/dissociation constants.

Those applications for the thermocycling taught by the present invention will find use, for example, as a diagnostic tool in hospitals and laboratories such as for identifying specific genetic characteristics in a sample from a patient, in biotechnology research such as for the development of new drugs, identification of desirable genetic characteristics, etc., in biotechnology industry-wide applications, and in scientific research and development efforts.

Thus, the samples subjected to the thermocycling methods of the present invention will vary depending on the particular application for which the methods are being used. Samples will typically be biological samples, although accurate heating and cooling of non-biological samples is equally within the scope of this invention.

A suitable reaction vessel according to the methods of the present invention is one in which extremely low volumes of sample can be effectively tested, including sample volumes in the nanoliter range. The sample vessel must be made of a material that allows the penetration of IR light wavelengths, such as quartz glass, glass, silicon, transparent plastics, and the like. Preferably, the reaction vessel or container will have a high surface-to-volume ratio. A high surface-to-volume ratio leads to a decrease in the thermal time constant, which can lead to an increase in the efficiency of the thermocycling. A high surface-to-volume ratio, while not as important for the heating step, is related to the effectiveness of the cooling step. Various examples of suitable reaction vessels can be given, including but not limited to, microchambers, capillary tubes, microchips and microtiter plates.

A preferred example of a suitable reaction vessel is a microchamber made from thin-walled glass. Another preferred embodiment is a glass capillary tube. Such capillaries are typically used in capillary electrophoresis (“CE”). Suitable inner diameters of the capillaries having an outer diameter of about 370 μm typically vary between about 15 μm and 150 μm. Thermal gradients that lead to convection are substantially reduced in capillary tubes which are available commercially.

Another preferred example of a suitable reaction vessel is the channel structure incorporated into a microfabricated device, such as the microfabricated substrate described by Wilding et al. in Nucleic Acids Res., 24:380-385 (1996), and U.S. Pat. Nos. 5,726,026 and 6,184,029, which are encorporated herein by reference. Other reaction vessels with characteristics suitable for rapid thermocycling are shown in U.S. Pat. Nos. 6,413,766 and 6,210,882, which are incorporated herein by reference.

Any other reaction vessel, such as a microtiter plate (96, 384 or 1636 wells), can be used according to the methods of the present invention, provided that the vessel is made of a material which allows IR radiation to directly heat the sample and has a surface-to-volume ratio sufficient to allow for cooling within the time parameters discussed below. A method for preparing a suitable microfabricated device is discussed in the example section. Further guidance in preparing such microfabricated device is provided, for example, in U.S. Pat. Nos. 5,250,263; 5,296,114; Harrison et al., Science 261:895-897 (1993); and McCormick et al., Anal. Chem., 69:2626-2630 (1997).

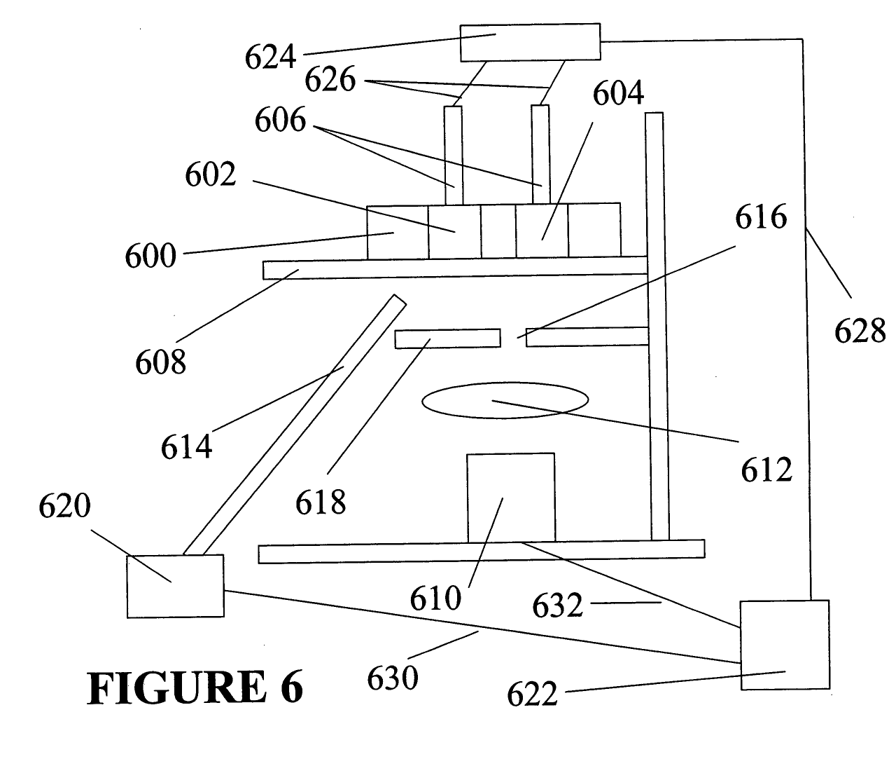

A preferred system for thermocycling of the present invention is depicted in FIG. 6, which shows the system of the present invention in which microchip 600 contains a first entrenched reservoir 602 and a second entrenched reservoir 604. The entrenched reservoirs 602, 604, each contains a remote temperature sensor 606. As shown in FIG. 6, the microchip 600 is preferably placed on a movable stage 608, which may be generally ring-like to leave the underside of the microchip 600 exposed, and which can be motorized or moved manually. A cooling jet 614 is directed underneath the reservoirs 602, 604. Although only one cooling jet 614 is shown, multiple cooling jets may be used to direct air above and/or below the reservoirs 602, 604. A lamp 610 has its emitted light filtered by a filter 612. The light to which the entrenched reservoirs 602, 604 are exposed is further limited by an aperture 616 and a light restricting device 618. It will be appreciated that the stage 608 is a frame that supports the microchip 600 on its periphery and that the microchip 600 is therefore exposed to the light from lamp 610.

It is preferable that the remote temperature sensors 606, the cooling jet 614 and the heating lamp 610 as shown in FIG. 6 are operatively associated with a microprocessor 622. The remote temperature sensors 606 are electrically connected to an optical switch 624, such as that depicted in FIG. 5, by electrical connections 626. The cooling jet 614 is preferably associated with a compressed gas source 620 which is electrically connected to the microprocessor 622 through an electrical connection 630. The heating lamp 610 is also connected to the microprocessor 622 through a second electrical connection 632. The microprocessor 622 preferably contains systems for controlling and receiving data from each of the heating lamp 610, the compress gas source 620, and the remote temperature sensors 606.

Although FIG. 6 shows only two remote temperature sensors (606) associated with two reservoirs (602, 604), a plurality of temperature sensors/reservoirs are appropriate for the present invention. For example, if a microplate is used to provide the reservoirs, the number of remote temperature sensors used can be up to 96, 384, or 1536, depending on the number of reservoirs being used on the plate.

As can be seen from FIG. 6, according to the present invention, a remote heat source, a remote cooling source, and remote temperature sensors are used. That allows for the repeated introduction of any number of reaction vessels in and out of the apparatus. Thus, the present invention provides an economic advantage over other thermocycling apparatus, in that it is only a relatively inexpensive microchip, capillary tube, or other reaction vessel that must be changed for every sample. Some methods provided in the art require the physical attachment of the heating, cooling, and/or temperature sensing systems to the reaction vessel itself. Therefore, unless the reaction vessel could be completely cleaned to ensure that contamination from one sample to another did not occur, a new chip attached to a new heating, cooling, and/or temperature sensing device would have to be provided for every sample. While for ease of reference, only two sample-containing vessel were shown and/or described in FIG. 6, it is equally within the scope of the present invention to thermocycle more than two samples at the same time. In addition, because the heating and cooling sources are relatively stationary in the apparatus of the present invention, the reaction vessel can be moved in any direction relative to the heating and/or cooling sources.

Heating of the sample is accomplished through the use of optical energy from a remote heat source. Preferably, this optical energy is derived from an IR light source which emits light in the wavelengths known to heat water, which is typically in the wavelength range from about 0.775 μm to 7000 μm. For example, the infrared activity absorption bands of sea water are 1.6, 2.1, 3.0, 4.7 and 6.9 μm with an absolute maximum for the absorption coefficient for water at around 3 μm. The IR wavelengths are directed to the vessel containing the sample, and because the vessel is made of a clear or translucent material, the IR waves act directly upon the sample to cause heating of the sample. Although some heating of the sample might be the result of the reaction vessel itself absorbing the irradiation of the IR light, heating of the sample is primarily caused by the direct action of the IR wavelengths on the sample itself.

Typically, the heating source will be an IR source, such as an IR lamp, an IR diode laser or an IR laser. An IR lamp is prefer-red, as it is inexpensive and easy to use. Preferred IR lamps are halogen lamps and tungsten filament lamps. Halogen and tungsten filament lamps are powerful, and can feed several reactions running in parallel. A tungsten lamp has the advantages of being simple to use and inexpensive, and can almost instantaneously (90% lumen efficiency in 100 msec) reach very high temperatures. A particularly preferred lamp is the CXR, 8V, 50 W tungsten lamp available from General Electric. That lamp is inexpensive and convenient to use, because it typically has all the optics necessary to focus the IR radiation onto the sample; no expensive lens system/optics will typically be required.

In a preferred embodiment, the optical energy is focused on the sample by means of IR transmissible lenses so that the sample is homogeneously irradiated. That technique avoids “hotspots” that could otherwise result in the creation of undesirable temperature differences and/or gradients, or the partial boiling of the sample. The homogeneous treatment of the sample vessel with optical energy therefore contributes to a sharper temperature profile. The homogenous sample irradiation can further be enhanced through the use of a mirror placed on the opposite site of the IR source, such that the reaction vessel is placed between the IR source and the mirror. That arrangement reflects the radiation back onto the sample and substantially reduces thermal gradients in the sample. Alternatively, the radiation can be delivered by optical IR-transparent fiberglass, for example, optical fiberglass made from waterfree quartz glass that is positioned around the reaction vessel and that provides optimal irradiation of the sample.

Heating can be effected in either one step, or numerous steps, depending on the desired application. For example, a particular methodology might require that the sample be heated to a first temperature, maintained at that temperature for a given dwell time, then heated to a higher temperature, and so on. As many heating steps as necessary can be included.

Similarly, cooling to a desired temperature can be effected in one step, or in stepwise reductions with a suitable dwell time at each temperature step. Positive cooling is preferably effected by use of a non-contact air source that forces air at or across the vessel. Preferably, that air source is a compressed air source, although other sources could also be used. It will be understood by those skilled in the art that positive cooling results in a more rapid cooling than simply allowing the vessel to cool to the desired temperature by heat dissipation. Cooling can be accelerated by contacting the reaction vessel with a heat sink comprising a larger surface than the reaction vessel itself, the heat sink is cooled through the non-contact cooling source. The cooling effect can also be more rapid if the air from the non-contact cooling source is at a lower temperature than ambient temperature.

Accordingly, the non-contact cooling source should also be positioned remotely to the sample or reaction vessel, while being close enough to effect the desired level of heat dissipation. Both the heating and cooling sources should be positioned so as to cover the largest possible surface area on the sample vessel. The heating and cooling sources can be alternatively activated to control the temperature of the sample. It will be understood that more than one cooling source can be used.

Positive cooling of the reaction vessel dissipates heat more rapidly than the use of ambient air. The cooling means can be used alone or in conjunction with a heat sink. A particularly preferred cooling source is a compressed air source. Compressed air is directed at the reaction vessel when cooling of the sample is desired through use, for example, of a solenoid valve which regulates the flow of compressed air at or across the sample. The pressure of the air leaving the compressed air source can have a pressure of anywhere between 10 and 60 psi, for example. Higher or lower pressures could also be used. The temperature of the air can be adjusted to achieve the optimum performance in the thermocycling process. Although in most cases compressed air at ambient temperature can create enough of a cooling effect, the use of cooled, compressed air to more quickly cool the sample, or to cool the sample below ambient temperature might be desired in some applications.

Monitoring and controlling is accomplished by use of a microprocessor or computer programmed to monitor temperature and regulate or change temperature. An example of such a program is the LabVIEW program, available from National Instruments, Austin, Tex. Feedback from the temperature sensor is sent to the computer. In one embodiment, the temperature sensor provides an electrical input signal to the computer and/or other controller, which signal corresponds to the temperature of the sample.

Signals from the computer, in turn, control and regulate the heating and cooling means, such as through one or more switches and/or valves. The desired temperature profile, including dwell times, is programmed into the computer, which is operatively associated with heating and cooling means so as to control heating and cooling of the sample based upon feedback from the temperature sensor and the predetermined temperature profile.

Accordingly, the methods of the present invention provide for the use of virtually any temperature profile/dwell time necessary. For example, cleavage of proteins through use of proteases or digestion enzymes might require use of different temperatures, each of which must be precisely maintained for various amounts of time. Activation of restriction endonucleases might similarly require achieving and maintaining two or three different temperatures. Protein or peptide sequencing can require the steady maintenance of a high temperature for an extended period of time.

The above apparatus provide for rapid heating and cooling of a sample in a precise and easy to replicate manner. Heating can be effected for example as quickly as 10° C. per second when using approximately 15 to 50 μL volumes of sample in a microchamber and as rapidly as 100° C. per second when using nL volume samples in a capillary. Cooling can be effected quickly, typically in the range of between about 5 and 50° C. per second. The increased effectiveness of heating and cooling improves the cycling process and sharpens the temperature profile. This means that the desired reaction can be conducted under more optimal thermal conditions than in conventional instruments. Thermal gradients in the reaction medium frequently observed in instrumentation using a contact heat source are detrimental to the specificity of the reaction. Those thermal gradients are substantially reduced in the IR mediated heating, particularly when the heat source is strong enough to penetrate the aqueous mixture and provide sufficient irradiation to the opposite side of the reaction vessel. Non-contact, remote rapid cooling, heating, and temperature sensing, such as that provided in the present invention, also contributes to the ability to obtain sharp transition temperatures in minimum time and to achieve fast and accurate temperature profiles.

Without further description, it is believed that one of ordinary skill in the art can, using the preceding description and the following illustrative examples, make and utilize the compounds of the present invention and practice the claimed methods. The following example is given to illustrate the present invention. It should be understood that the invention is not to be limited to the specific conditions or details described in this example.

### EXAMPLE

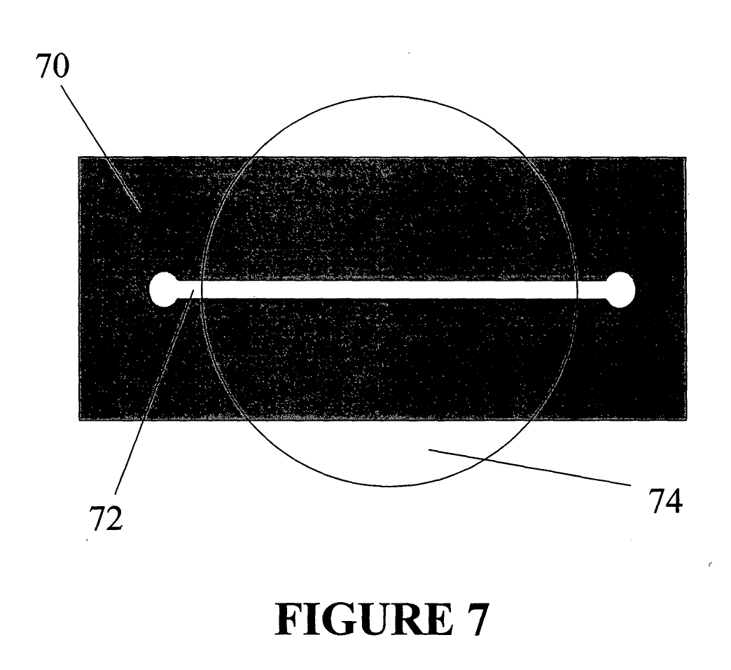

In order to verify that the optical interferometric sensor approach could adequately measure solution temperature within a glass microchip, a microdevice prepared in our laboratory for IR-mediated thermocycling was employed. FIG. 7 provides details on the configuration and dimensions of that microchip. The microchip consists of two pieces of borofloat glass. The bottom piece (70) has been etched to produce a channel (72) that is 150 microns deep and 300 microns wide at the top. A 150-micron cover plate (74) is bonded to the bottom plate via a UV-curable adhesive. IR-mediated heating of solution is achieved by placing the microchip in the path of the IR-light source. Temperature control for cycling purposes is achieved through feedback from the thermocouple to control the IR-source voltage.

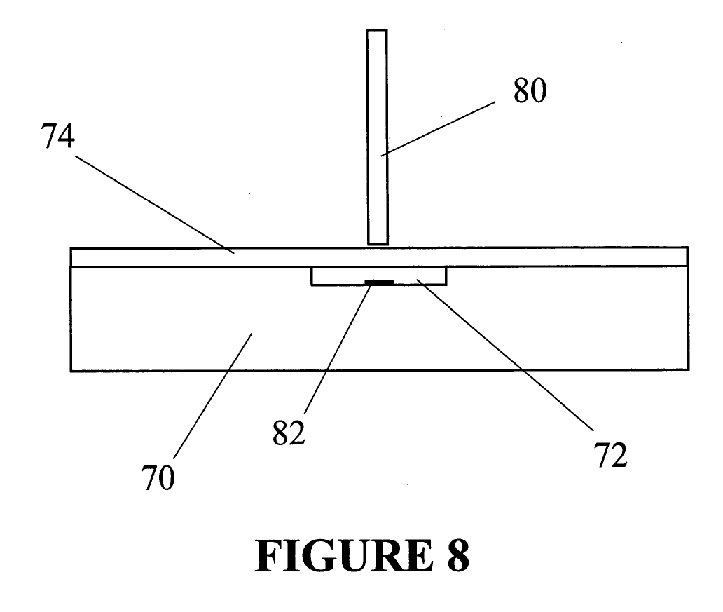

The effectiveness of the optical interferometric sensor approach for solution temperature sensing was tested by placing an optical fiber of the EFPI above the chamber where the solution was held in the microchip. The fiber used was a commercially-available single mode optical fiber modified with a lens, and was connected to a commercially-available fiberoptic support system. A schematic diagram of the EFPI set-up in conjunction with the IR-heating system is shown in FIG. 8. The fiber optic cable 80 is held flush to the top of the microchip cover plate 74. A gold-chrome spot 82 has been sputtered on the channel-side of the bottom plate to increase the amount of light returning to the fiber optic cable 80. Interference from the IR-source is not observed as the gold-chrome layer reflects any light from the source coming through the bottom layer 82. The footprint of the gold-chrome spot 82 is small relative to the area heated by the IR-source and does not affect the mechanism and efficiency of IR-mediated heating.

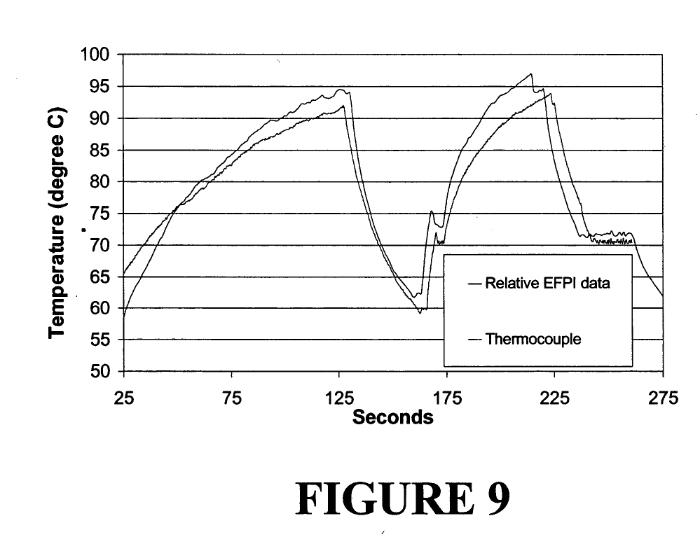

A thermocycling program was initiated between 60° C., 72° C., and 94° C. (typical temperatures used in PCR) with a thermocouple in place to control the lamp intensity using an computer program. During thermocycling, the EFPI sensor was in place and the response relative to the temperature change was observed. As the EFPI response is proportional to the refractive index of the solution, the raw EFPI data is converted to temperature measurements using a correlation specifically designed to account for the changes in refractive index of water with temperature. Using the EFPI data that corresponded to 60° C. (as detected by the thermocouple) the relative EFPI response was determined for each temperature. The temperature profiles for the thermocouple and the one calculated from the EFPI raw data are shown in FIG. 9 (thermocouple shown commencing at approximately 66° C. and terminating at approximately 71° C.; Relative EFPI data shown commencing at approximately 60° C. and terminating at approximately 62° C.). The calculated temperature from the EFPI sensor and the actual temperature, as determined by the thermocouple, track well together. These initial experiments indicate that it will be possible to measure temperature remotely using EFPI.

Although certain presently preferred embodiments of the invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

What is claimed is:

1. An apparatus for thermocycling comprising
a small volume reaction vessel;
a remote temperature sensor for monitoring the temperature of a fluid sample inside the reaction vessel; and
a microprocessor operatively associated with the temperature sensor.

2. The apparatus of claim 1, wherein the remote temperature sensor is an optical interferometric sensor.

3. The apparatus of claim 2, further comprising a heating means for heating the reaction vessel and a cooling means for cooling the reaction vessel, both the heating means and cooling means are operatively associated with the microprocessor.

4. The apparatus of claim 3, wherein the heating means is an IR source.

5. The apparatus of claim 4, wherein the IR source is selected from the group consisting of a halogen lamp and a tungsten lamp.

6. The apparatus of claim 4, wherein the IR source is disposed in a spaced relationship with respect to the reaction vessel.

7. The apparatus of claim 3, wherein the cooling means is a compressed air source.

8. The apparatus of claim 7, wherein the compressed air source has means for chilling air.

9. The apparatus of claim 2, wherein the reaction vessel is selected from the group consisting of a capillary tube, a microchip, a microchamber, and a microtiter plate.

10. The apparatus of claim 2, wherein the microprocessor comprises means for effecting DNA amplification in a sample.

11. The apparatus of claim 2, wherein the microprocessor comprises means for converting the frequency output of the EFPI to temperature.

12. The apparatus of claim 2, wherein the small volume vessel holds about 0.4 μL to about 100 μL of the fluid sample.

13. The apparatus of claim 2, wherein the optical interferometric sensor is an extrinsic Fabry-Perot interferometer (EFPI).

14. A temperature sensor for sensing the temperature of a small volume solution comprising
an optical interferometric sensor; and
a support system associated with the optical interferometric sensor for displaying the out put of the optical interferometric sensor.

15. The temperature sensor of claim 14, wherein the small volume solution is from about 100 pL to about 100 μL.

16. The temperature sensor of claim 14, further comprising a microprocessor for receiving signals from the support system and converting the signals into a temperature of the small volume solution.

17. The temperature sensor of claim 14, wherein the support system is a spectrophotometer.

18. The temperature sensor of claim 14, wherein the optical interferometric sensor is an extrinsic Fabry-Perot interferometer (EFPI).

19. A method for measuring the temperature of a small volume solution comprising the steps of:
providing an optical interferometric sensor;
providing a small volume of a sample;
interrogating the small volume with the optical interferometric sensor to obtain an output; and
converting the output of the optical interferometric sensor to temperature using a calibration curve.

20. The method of claim 19, wherein the small volume of a sample is contained in a capillary tube, a microchip, a microchamber, or a microtiter plate.

21. The method of claim 19I, wherein the calibration curve is obtained by interrogating samples with known temperatures using the optical interferometric sensor.

22. The method of claim 19, wherein the converting step is accomplished by a microprocessor.

23. The method of claim 19, wherein the small volume is about 0.4 μL to about 100 μL.

24. The method of claim 19, wherein the optical interferometric sensor is an extrinsic Fabry-Perot interferometer (EFPI).
